(19) United States
(12) Patent Application Publication
(10) Pub. No.: US 2026/0343551 A1
(43) Pub. Date: Oct. 29, 2026

(54) LOGICAL CHANNEL CONFIGURATION FOR LAYER 2 REPORTING

(71) Applicant: QUALCOMM Incorporated, San Diego, CA (US)

(72) Inventors: Sherif ELAZZOUNI, San Diego, CA (US); Ozcan OZTURK, San Diego, CA (US)

(21) Appl. No.: 19/299,762

(22) Filed: Aug. 14, 2025

Related U.S. Application Data
(60) Provisional application No. 63/794,477, filed on Apr. 25, 2025.

(51) Int. Cl. H04W 72/21; H04W 36/00

(52) U.S. Cl. CPC H04W 72/21; H04W 36/0058

(57) ABSTRACT

Various aspects of the present disclosure generally relate to wireless communication. In some aspects, a user equipment (UE) may receive, from a network node, configuration information indicating a plurality of logical channels (LCHs) that include a Layer 2 (L2)-based LCH, where the L2-based LCH may be configured for L2 information. The UE may receive, from the network node, an uplink grant that indicates an amount of resources and a prioritization configured for an uplink transmission. The UE may transmit, to the network node, the uplink transmission, where the uplink transmission includes information buffered at the L2-based LCH. Numerous other aspects are described.

### CROSS-REFERENCE TO RELATED APPLICATION

This Patent Application claims priority to U.S. Provisional Patent Application No. 63/794,477, filed on Apr. 25, 2025, entitled “LOGICAL CHANNEL CONFIGURATION FOR LAYER 2 REPORTING,” and assigned to the assignee hereof. The disclosure of the prior Application is considered part of and is incorporated by reference into this Patent Application.

### FIELD OF THE DISCLOSURE

Aspects of the present disclosure generally relate to wireless communication and specifically relate to techniques, apparatuses, and methods associated with logical channel configuration for Layer 2 reporting.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

### SUMMARY

The systems, methods, and devices of this disclosure each have several innovative aspects, no single one of which is solely responsible for the desirable attributes disclosed herein.

Some aspects described herein relate to a user equipment (UE). The UE may include a processing system. The processing system may include one or more processors and one or more code-storing memories coupled with the one or more processors. The processing system may be configured to cause the UE to receive, from a network node, configuration information indicating a plurality of logical channels (LCHs) that include a Layer 2 (L2)-based LCH, wherein the L2-based LCH is configured for L2 information. The processing system may be configured to cause the UE to receive, from the network node, an uplink grant that indicates an amount of resources and a prioritization configured for an uplink transmission. The processing system may be configured to cause the UE to transmit, to the network node, the uplink transmission, wherein the uplink transmission includes information buffered at the L2-based LCH.

Some aspects described herein relate to a network node. The network node may include a processing system. The processing system may include one or more processors and one or more code-storing memories coupled with the one or more processors. The processing system may be configured to cause the network node to transmit, to a UE, configuration information indicating a plurality of LCHs that include an L2-based LCH, wherein the L2-based LCH is configured for L2 information. The processing system may be configured to cause the network node to transmit, to the UE, an uplink grant that indicates an amount of resources and a prioritization configured for an uplink transmission. The processing system may be configured to cause the network node to receive, from the UE, the uplink transmission, wherein the uplink transmission includes information buffered at the L2-based LCH.

Some aspects described herein relate to a method of wireless communication performed by a UE. The method may include receiving, from a network node, configuration information indicating a plurality of LCHs that include an L2-based LCH, wherein the L2-based LCH is configured for L2 information. The method may include receiving, from the network node, an uplink grant that indicates an amount of resources and a prioritization configured for an uplink transmission. The method may include transmitting, to the network node, the uplink transmission, wherein the uplink transmission includes information buffered at the L2-based LCH.

Some aspects described herein relate to a method of wireless communication performed by a network node. The method may include transmitting, to a UE, configuration information indicating a plurality of LCHs that include an L2-based LCH, wherein the L2-based LCH is configured for L2 information. The method may include transmitting, to the UE, an uplink grant that indicates an amount of resources and a prioritization configured for an uplink transmission. The method may include receiving, from the UE, the uplink transmission, wherein the uplink transmission includes information buffered at the L2-based LCH.

Some aspects described herein relate to a non-transitory computer-readable medium that stores a set of instructions for wireless communication by a UE. The set of instructions, when executed by one or more processors of the UE, may cause the UE to receive, from a network node, configuration information indicating a plurality of LCHs that include an L2-based LCH, wherein the L2-based LCH is configured for L2 information. The set of instructions, when executed by one or more processors of the UE, may cause the UE to receive, from the network node, an uplink grant that indicates an amount of resources and a prioritization configured for an uplink transmission. The set of instructions, when executed by one or more processors of the UE, may cause the UE to transmit, to the network node, the uplink transmission, wherein the uplink transmission includes information buffered at the L2-based LCH.

Some aspects described herein relate to a non-transitory computer-readable medium that stores a set of instructions for wireless communication by a network node. The set of instructions, when executed by one or more processors of the network node, may cause the network node to transmit, to a UE, configuration information indicating a plurality of LCHs that include an L2-based LCH, wherein the L2-based LCH is configured for L2 information. The set of instructions, when executed by one or more processors of the network node, may cause the network node to transmit, to the UE, an uplink grant that indicates an amount of resources and a prioritization configured for an uplink transmission. The set of instructions, when executed by one or more processors of the network node, may cause the network node to receive, from the UE, the uplink transmission, wherein the uplink transmission includes information buffered at the L2-based LCH.

Some aspects described herein relate to an apparatus for wireless communication. The apparatus may include means for receiving, from a network node, configuration information indicating a plurality of LCHs that include an L2-based LCH, wherein the L2-based LCH is configured for L2 information. The apparatus may include means for receiving, from the network node, an uplink grant that indicates an amount of resources and a prioritization configured for an uplink transmission. The apparatus may include means for transmitting, to the network node, the uplink transmission, wherein the uplink transmission includes information buffered at the L2-based LCH.

Some aspects described herein relate to an apparatus for wireless communication. The apparatus may include means for transmitting, to a UE, configuration information indicating a plurality of LCHs that include an L2-based LCH, wherein the L2-based LCH is configured for L2 information. The apparatus may include means for transmitting, to the UE, an uplink grant that indicates an amount of resources and a prioritization configured for an uplink transmission. The apparatus may include means for receiving, from the UE, the uplink transmission, wherein the uplink transmission includes information buffered at the L2-based LCH.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless communication network.

FIG. 2 is a diagram of an example in accordance with configuring Layer 2 (L2)-based logical channels (LCHs) for L2 information.

FIG. 3 is a diagram illustrating an example associated with signaling that enables LCH configuration for L2 reporting.

FIG. 4 is a diagram illustrating an example process performed, for example, at a user equipment (UE) or an apparatus of a UE.

FIG. 5 is a diagram illustrating an example process performed, for example, at a network node or an apparatus of a network node.

FIG. 6 is a diagram of an example apparatus for wireless communication.

FIG. 7 is a diagram of an example apparatus for wireless communication.

### DETAILED DESCRIPTION

In the evolution of mobile communication networks including different radio access technologies (RATs), a confluence of challenges arises to efficiently manage uplink resources, such as in the context of medium access control (MAC) layer (or Layer 2 (L2)) signaling. For example, as different RATs develop (such as sixth generation (6G) wireless communications), MAC control elements (MAC-CEs) may include more comprehensive information that may have otherwise been included in other types of reports. Such inclusion of information may increase data sizes of MAC-CEs. Accordingly, the size and flexibility of MAC-CEs may enable MAC-CEs to include more granular information related to various network parameters, such as one or more of cell information, beam information, transmission configuration indicators (TCIs), or hybrid automatic repeat request (HARQ) processes.

However, shifting toward increased in-band signaling complexity may increase complexity in network management of L2 reporting. For example, wireless devices (such as a network node or a user equipment (UE)) may experience difficulty in predicting the exact size of a triggered MAC-CE or other L2 reports, especially in congested network conditions where determining the appropriate grant size becomes a complex task. Moreover, as UEs generate L2 reports with larger data sizes, there is a risk of excessive consumption of uplink resources. For instance, allocating more uplink resources to accommodate for larger L2 reports may impact the traffic on data radio bearers (DRBs) and signaling radio bearers (SRBs), and may additionally increase difficulty in establishing a prioritization mechanism for L2 reporting. Accordingly, the interplay between logical channel (LCH) prioritization, the dynamic nature of MAC-CEs, and the allocation of grant resources based on relative priorities, bucket sizes, and prioritized bit rates further complicates data prioritization for uplink transmissions.

Various aspects relate generally to the management of uplink resources in wireless communication networks, particularly the allocation and prioritization of L2 signaling. Some aspects more specifically relate to a UE receiving configuration information from a network node that indicates a plurality of LCHs, including an L2-based LCH configured for L2 information. The UE may also receive an uplink grant from the network node, which indicates an amount of resources and a prioritization configured for an uplink transmission. Accordingly, the UE transmits the uplink transmission, which may include information buffered at the L2-based LCH. In some aspects, the L2-based LCH can be one of several such channels indicated by the configuration information (e.g., L2-based LCHs, LCHs for DRBs, or LCHs for SRBs, among other examples). The configuration information may also indicate a priority for the L2-based LCH through a logical channel priority (LCP) scheme, and may further specify a set of priorities for various MAC-CEs mapped to the L2-based LCH.

Particular aspects of the subject matter described in this disclosure can be implemented to realize technical benefits. By providing configuration information for a dedicated L2-based LCH, the described techniques can optimize the management of uplink resources based on the current network conditions and quality of service (QoS) metrics, thereby reducing the likelihood of congestion and improving the efficiency of resource utilization. Additionally, the dynamic prioritization of MAC-CEs for the L2-based LCH, including the capability to adjust priorities in response to network congestion and latency metrics, enhances network performance by allowing real-time adjustments to transmission priorities. This dynamic approach allows for the conservation of network bandwidth and reduces the occurrence of retransmissions caused by congestion or mis-prioritized uplink data. Therefore, the implementation of a dedicated L2-based LCH and dynamic MAC-CE prioritization contributes to improved resource allocation in uplink transmissions, better adherence to QoS requirements, and an enhanced ability to maintain optimal network performance under varying conditions.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

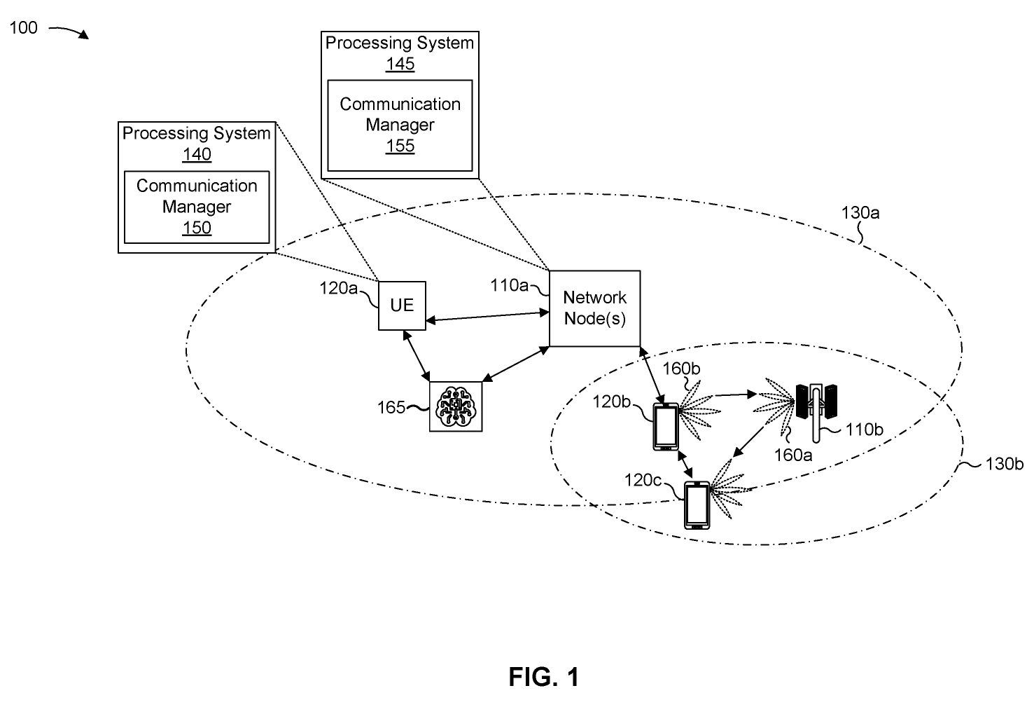

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A CU can communicate with a core network either directly (for example, via a backhaul link) or indirectly (for example, via one or more disaggregated control units, such as a non-real-time (Non-RT) RAN intelligent controller (RIC) associated with a Service Management and Orchestration (SMO) framework or a near-real-time (Near-RT) RIC). A DU may host one or more of a radio link control (RLC) layer, a MAC layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. A CU may communicate with one or more DUs via respective midhaul links, such as via F1 interfaces. Each of the DUs may communicate with one or more RUs via respective fronthaul links. Each of the RUs may communicate with one or more UEs 120 via respective RF access links. In some deployments, a UE 120 may be simultaneously served by multiple RUs.

In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment (for example, an open cloud (O-Cloud) platform). An SMO framework may support RAN deployment and provisioning of non-virtualized and virtualized network elements.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)- reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110aor the UE 120a(for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples.

In some examples, one or more MAC-CEs may be triggered and transmitted by the UE 120 only if an available uplink grant size is sufficient to accommodate the MAC-CEs. In other words, the transmission of these control elements may be contingent upon having enough allocated resources to include them in the data packet. In some examples, the UE 120 or network node 110 may operate according to a wireless communications standard (such as 3GPP technical specification (TS) 38.321). In such operations, the transmission of a MAC-CE for power headroom reports (PHRs) is conditional upon the availability of sufficient uplink resources (e.g., uplink resources above a threshold). For instance (referencing TS 38.321, clause 5.4.3.1), the MAC-CE for PHR, along with an associated subheader, may only be transmitted if the allocated uplink resources can accommodate a data size of the MAC-CE as a result of the LCP process.

If there are not enough uplink shared channel (UL-SCH) resources available to transmit a MAC-CE, the UE 120 can trigger an SR. Specifically, if UL-SCH resources are available for an upcoming uplink transmission and these resources can accommodate the timing advance report MAC-CE and the MAC-CE subheader as a result of logical channel priority, the UE 120 operates according to a multiplexing and assembly procedure to generate the Timing Advance Report MAC-CE (e.g., as defined in TS 38.321 clause 6.1.3.56). However, if the UL-SCH resources are insufficient, and if the information element (IE) timingAdvanceSR is configured with the value enabled, the UE 120 triggers an SR triggered to request additional resources. This ensures that the one or more MAC-CEs can be transmitted when sufficient resources become available.

When a data size of a MAC-CE does not fit into the available grant, the UE 120 may perform one or more operations. In some examples, the MAC-CE is not sent if the available grant is insufficient to accommodate it. In other words, the UE 120 may withhold the control element until a suitable grant is available in future transmissions. In some examples, the MAC-CE is not transmitted and SR is triggered. For instance, the MAC-CE is not transmitted due to the insufficient grant size, and an SR is triggered. The SR may be a request (e.g., 1 bit) for additional uplink resources, prompting the network to allocate a larger grant in subsequent transmissions to accommodate the MAC-CE. In some examples, the UE 120 may transmit a truncated version of the MAC-CE. For instance, a truncated version of the MAC-CE is transmitted if the full control element cannot fit into the available grant. In other words, a portion of the MAC-CE is sent, potentially omitting some information, but ensuring that at least part of the control element is communicated to the network.

As described herein, the transmission of a MAC-CE can be delayed if the UL-SCH grant resources are insufficient or unavailable. Some MAC-CEs trigger an SR to obtain enough resources for transmission. If the grant received in response to the SR is still insufficient to accommodate the MAC-CE, then the UE 120 may trigger and transmit another SR, continuing this process until a sufficiently large grant is received. However, various MAC-CEs (e.g., Long-Term Measurement (LTM) Report MAC-CEs) may experience problems with transmission delay. For instance, the event-triggered Layer 1 (L1) Measurement Report is particularly large (compared to other MAC-CEs) because of including beam-level measurements. This MAC-CE is also latency-sensitive, as delays in transmission can impact a network node 110 ability to perform a cell switch and may lead to Radio Link Failure (RLF) at the UE 120. Accordingly, the size and latency sensitivity of the MAC-CE means that any delay or truncation could significantly reduce network node 110 performance and reliability.

Additionally, various RATs (such as 6G) are associated with the transmission of more information within MAC-CEs. For instance, some RATs may exhibit the inclusion of information previously included in UCI reporting (e.g., CSI reporting) and some uplink associated information (UAI) into a unified L2 signaling scheme (e.g., increasing the amount of information included in MAC-CEs). This approach would result in MAC-CEs (in 6G) being larger in size due to the inclusion of more detailed information, such as cell information, beam information, TCI, and HARQ process granularity level data. The increased size and complexity of these MAC-CEs pose several challenges. For instance, the greater amount of in-band signaling may increase complexity for the network node 110 to accurately determine the size of the triggered MAC-CE, especially in congested network node 110 conditions. This uncertainty complicates the process of allocating the appropriate grant size for transmission. Additionally, or alternatively, the transmission of more measurements via MAC-CEs heightens the urgency of transmitting these control elements quickly. Therefore, delays in transmission due to waiting for multiple uplink grants can reduce network node 110 communication quality of service, as timely delivery of this information is critical for network node 110 performance and reliability. Ensuring that MAC-CEs are transmitted promptly, without waiting for multiple rounds of grant allocation, is essential in order to maintain the efficiency and effectiveness of the network node 110.

In some aspects, the UE 120 may include a communication manager 150. As described in more detail elsewhere herein, the communication manager 150 may receive, from a network node, configuration information indicating a plurality of LCHs that include an L2-based LCH, wherein the L2-based LCH is configured for L2 information; receive, from the network node, an uplink grant that indicates an amount of resources and a prioritization configured for an uplink transmission; and transmit, to the network node, the uplink transmission, wherein the uplink transmission includes information buffered at the L2-based LCH. Additionally, or alternatively, the communication manager 150 may perform one or more other operations described herein.

In some aspects, the network node 110 may include a communication manager 155. As described in more detail elsewhere herein, the communication manager 155 may transmit, to a UE, configuration information indicating a plurality of LCHs that include an L2-based LCH, wherein the L2-based LCH is configured for L2 information; transmit, to the UE, an uplink grant that indicates an amount of resources and a prioritization configured for an uplink transmission; and receive, from the UE, the uplink transmission, wherein the uplink transmission includes information buffered at the L2-based LCH. Additionally, or alternatively, the communication manager 155 may perform one or more other operations described herein.

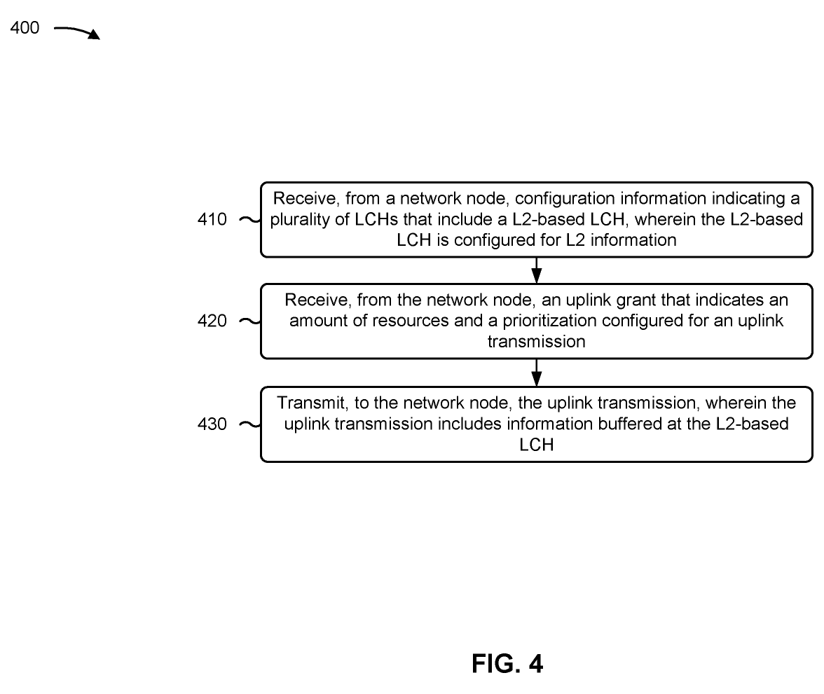

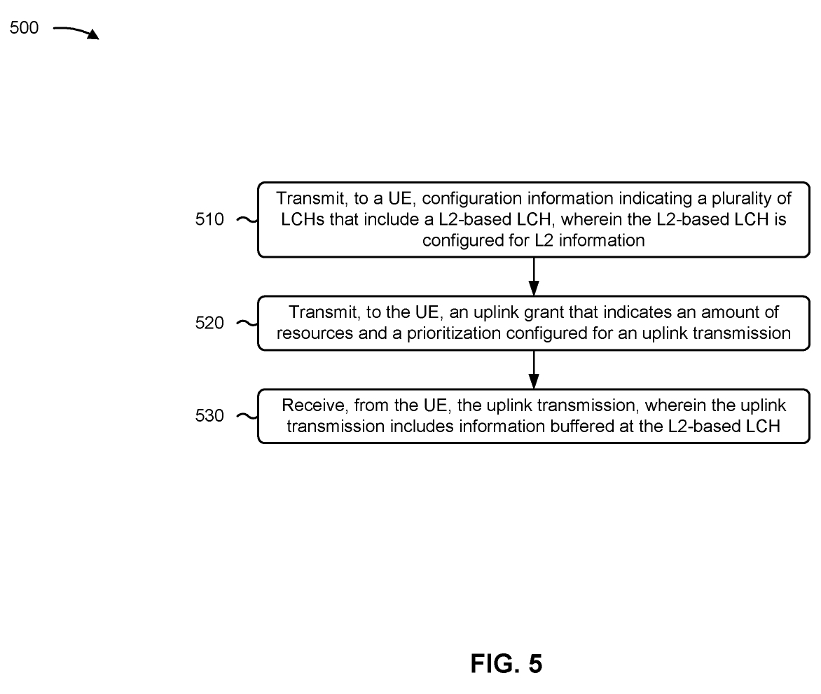

The network node 110, the processing system 145 of the network node 110, the UE 120, the processing system 140 of the UE 120, or any other component(s) of FIG. 1 may implement one or more techniques or perform one or more operations associated with LCH configuration for L2 reporting, as described in more detail elsewhere herein. For example, the processing system 145 of the network node 110, or the processing system 140 of the UE 120 may perform or direct operations of, for example, process 400 of FIG. 4, process 500 of FIG. 5, or other processes as described herein (alone or in conjunction with one or more other processors). Memory of the network node 110 may store data and program code (or instructions) for the network node 110. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, or the UE 120, may cause the one or more processors to perform process 400 of FIG. 4, process 500 of FIG. 5, or other processes as described herein. In some examples, executing instructions may include running the instructions, converting the instructions, compiling the instructions, or interpreting the instructions, among other examples.

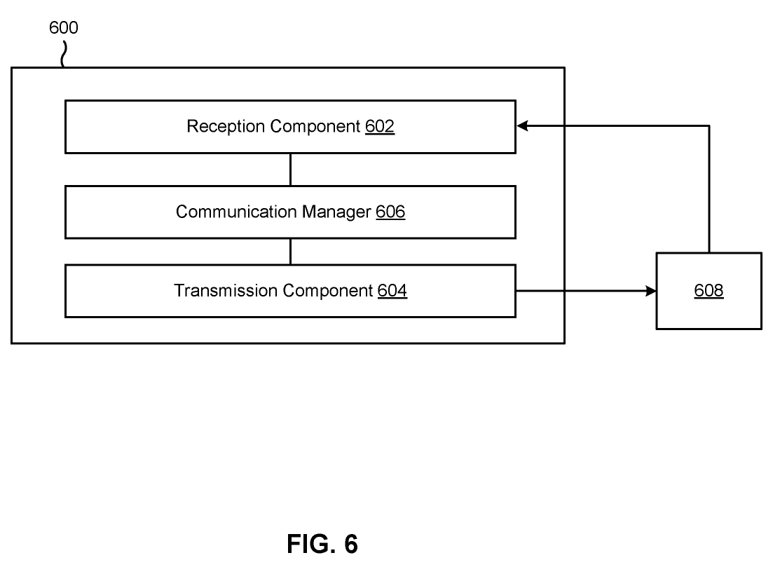

In some aspects, the UE 120 includes means for receiving, from a network node, configuration information indicating a plurality of LCHs that include an L2-based LCH, wherein the L2-based LCH is configured for L2 information; means for receiving, from the network node, an uplink grant that indicates an amount of resources and a prioritization configured for an uplink transmission; or means for transmitting, to the network node, the uplink transmission, wherein the uplink transmission includes information buffered at the L2-based LCH. The means for the UE 120 to perform operations described herein may include, for example, one or more of communication manager 150, processing system 140, a radio, one or more RF chains, one or more transceivers, one or more antennas, one or more modems, a reception component (for example, reception component 602 depicted and described in connection with FIG. 6), or a transmission component (for example, transmission component 604 depicted and described in connection with FIG. 6), among other examples.

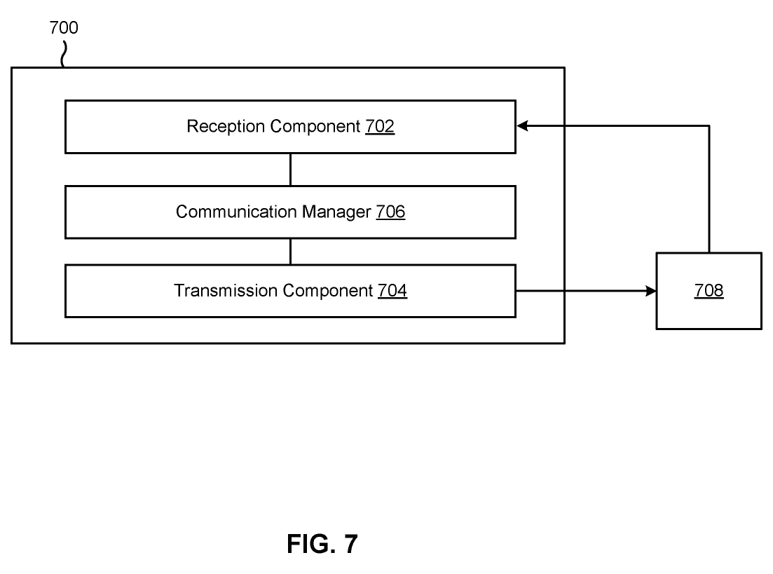

In some aspects, the network node 110 includes means for transmitting, to a UE, configuration information indicating a plurality of LCHs that include an L2-based LCH, wherein the L2-based LCH is configured for L2 information; means for transmitting, to the UE, an uplink grant that indicates an amount of resources and a prioritization configured for an uplink transmission; or means for receiving, from the UE, the uplink transmission, wherein the uplink transmission includes information buffered at the L2-based LCH. The means for the network node 110 to perform operations described herein may include, for example, one or more of communication manager 155, processing system 145, a radio, one or more RF chains, one or more transceivers, one or more antennas, one or more modems, a reception component (for example, reception component 702 depicted and described in connection with FIG. 7), or a transmission component (for example, transmission component 704 depicted and described in connection with FIG. 7), among other examples.

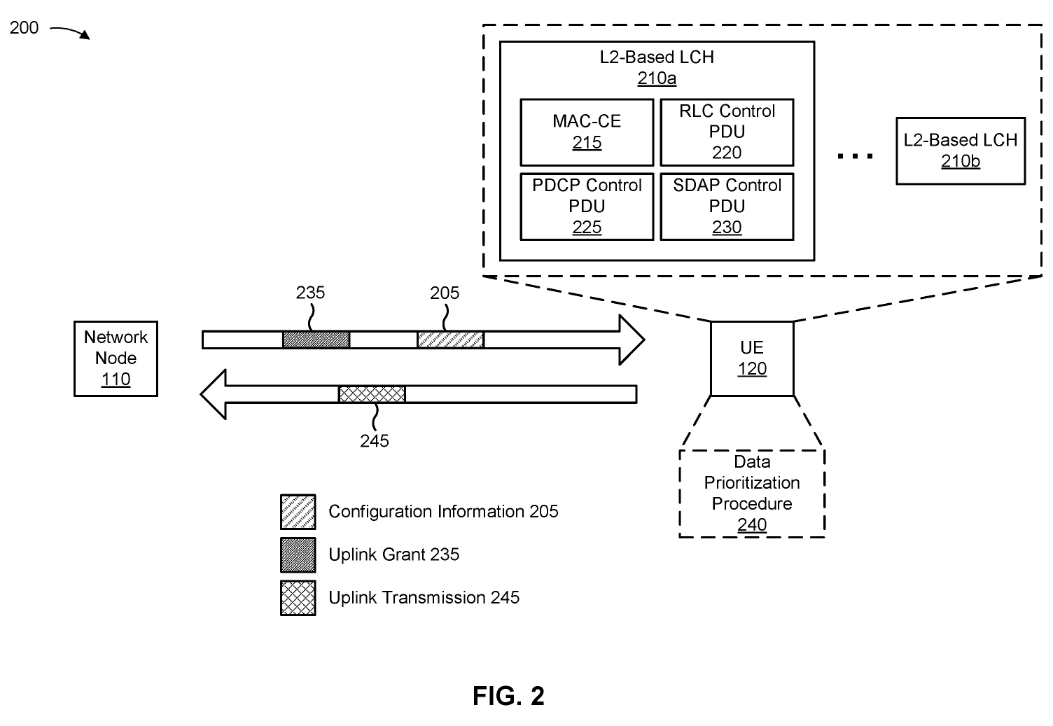

FIG. 2 is a diagram of an example 200 in accordance with configuring L2-based LCHs for L2 information. In some examples, example 200 may implement one or more aspects of example 100 in FIG. 1. For example, as shown, FIG. 2 includes the UE 120 and the network node 110 described elsewhere herein.

As shown in FIG. 2, the network node 110 may transmit, and the UE 120 may receive, configuration information 205. In some examples, the configuration information 205 may be transmitted via one or more of system information (e.g., including master information black (MIB) or SIB), RRC signaling, MAC signaling (e.g., including one or more MAC-CEs 215), or DCI signaling. Further description of the configuration information 205 provided elsewhere.

In some examples, the configuration information 205 can configure one or more L2-based LCHs 210 (e.g., L2-based LCH 210a and 210b). For example, the configuration information 205 may indicate a first LCH identifier for the L2-based LCH 210a and a second LCH identifier for the L2-based LCH 210b. While example 200 includes the UE 120 configured and allocated with two L2-based LCHs 210, in other examples, the configuration information 205 may indicate any number of LCH identifiers that allocate any number of L2-based LCHs 210.

The L2-based LCHs 210 may differ from other types of LCHs configured at the UE 120 (such as an LCH for data radio bearers (DRBs) or signaling radio bearers (SRBs)). For example, an LCH for DRBs is an LCH used to carry user data in a network. The LCH for DRBs may be configured to manage data flows that have quality of service (QoS) characteristics, such as latency, throughput, and reliability. Each DRB within the LCH corresponds to a particular service or application, such as voice calls, video streaming, or internet browsing. Additionally, an LCH for SRBs is an LCH dedicated to carrying control and signaling information between the UE 120 and the network node 110. These LCHs enable the establishment, maintenance, and management of the connection, by transporting signaling messages, such as RRC signaling. SRBs ensure that control information, such as connection setup, handover commands, and configuration updates, is transmitted reliably and with low latency. Examples of LCHs for DRBs and SRBs include but are not limited to a broadcast control channel (BCCH), a paging control channel (PCCH), a common control channel (CCCH), a dedicated control channel (DCCH), a dedicated traffic channel (DTCH), a multicast control channel (MCCH), and a multicast traffic channel (MTCH), among other examples.

Conversely to LCHs for DRBs or SRBs, the L2-based LCHs 210 are configured for the transmission of L2 information (e.g., exclusively used for L2 control and reporting information). In other words, the L2-based LCHs 210 may be used to balance the transmission and prioritization of DRB and SRB traffic with the transmission and prioritization of L2 reports. In some examples, the configuration information 205 may map one or more L2 reports to an L2-based LCH 210. For instance, as shown in FIG. 2, one or more MAC-CEs 215, one or more RLC control protocol data units (PDUs) 220, one or more PDCP control PDUs 225, one or more SDAP control PDUs 230, or a combination thereof may be mapped to the L2-based LCH 210a (or mapped to any other L2-based LCH 210). The MAC-CE 215 may be a type of control information used in wireless communication systems, within the MAC layer, to manage and control various aspects of the communication process, such as buffer status reporting, power headroom reporting, and SRs. The RLC control PDU 220 may be a type of data packet used within the RLC layer of a wireless communication system to manage and control the transmission of data, including functions such as error correction, flow control, and retransmission of lost or corrupted data. The PDCP control PDU 225 may be a type of data packet used within the PDCP layer of a wireless communication system to manage and control various functions such as header compression, security (encryption and integrity protection), and handover procedures. The SDAP control PDU 230 may be a type of data packet used within the SDAP layer to manage and control the mapping of QoS flows to DRBs.

In some examples, the configuration information 205 may configure the L2-based LCHs 210 according to a prioritized bit rate, a priority, or a bucket size duration. The prioritized bit rate may be a minimum data rate that an L2-based LCH 210 should maintain, ensuring that data flows receive a threshold bandwidth to satisfy a configured QoS. A priority may determine the order in which data from different LCHs is transmitted, with higher priority channels being served before lower priority channels, thus ensuring that more important or time-sensitive data is transmitted promptly. The bucket size duration may be a time interval used to control the flow of data into a transmission buffer of the UE 120. That is, the bucket size duration may define how much data can be accumulated in the buffer before being transmitted. Together, the prioritized bit rate, the priority, and the bucket size duration ensure that the UE 120 and network node 110 can handle multiple data streams with varying QoS configurations, prioritizing different types of data while efficiently managing available resources.

In some examples, the configuration information 205 may configure or indicate which MAC-CEs 215 (and the various control PDUs described herein) are included in the L2-based LCHs 210 and undergo LCH prioritization for grant building. LCH prioritization for grant building may include a process of determining the order in which data from different LCHs is included in an uplink transmission. For example, when the UE 120 receives an uplink grant 235 from the network node 110, the UE 120 decides which data to transmit based on the priority levels assigned to each LCH. Higher priority LCHs may be given precedence, ensuring that critical or time-sensitive data is transmitted first. This prioritization helps in efficiently utilizing the granted uplink resources, maintaining QoS for data flows, and ensuring timely delivery of information. Additionally, for other MAC-CEs 215 (or other control PDUs) that are not included in the L2-based LCHs 210, the UE 120 may perform a predefined prioritization procedure (e.g., a MAC prioritization). For example, the MAC prioritization may refer to one or more predefined rules and mechanisms established by a wireless communication standard, (such as those set by 3GPP), to manage the order in which data is transmitted at the MAC layer. Therefore, for a first MAC-CE 215 that is mapped to the L2-based LCH 210a the UE 120 may use LCH prioritization for grant building, and for a second MAC-CE 215 that is not mapped to an L2-based LCH 210, the UE 120 may use the predefined prioritization procedure.

In some examples, there may be multiple L2-based LCHs 210 that include different MAC-CEs 215 where one L2-based LCH 210 includes a group of MAC-CEs 215 with similar QoS characteristics. In other words, MAC-CEs 215 that share comparable QoS characteristics, such as latency, reliability, and throughput, may be mapped to a same L2-based LCH 210. These MAC-CEs 215 may be grouped together based on similar service characteristics to ensure that the MAC-CEs in the group of MAC-CEs 215 each receive comparable prioritization for transmission from the UE 120 to the network node 110. This approach helps maintain the desired level of service quality for different types of control information, contributing to a more reliable and efficient communication system. For instance, the L2-based LCH 210a may include a first group of MAC-CEs 215 associated with latency metrics that satisfy a latency threshold (e.g., latency-sensitive MAC-CEs 215) and the L2-based LCH 210b may include a second group of MAC-CEs 215 associated with latency metrics that do not satisfy the latency threshold (e.g., non-latency-sensitive MAC-CEs 215). Accordingly, the L2-based LCH 210a may have a higher priority for uplink transmissions 245 over the L2-based LCH 210b to accommodate for the latency sensitive MAC-CEs 215.

In some examples, the configuration information 205 may configure the priority for an L2-based LCH 210 similarly to a priority for an LCH for SRBs or DRBs (e.g., via an LCP parameters). For example, the priority for the L2-based LCHs 210 may be configured via LCP parameters, which are a set of parameters indicated via the configuration information 205 (e.g., via RRC signaling). These LCP parameters may include the priority level, which may be a numerical value indicating the importance of an LCH relative to other LCHs. Higher priority values correspond to higher priority data flows, ensuring that higher priority data flows are transmitted first when uplink resources are allocated. Additionally, the LCP parameters may include the prioritized bit rate and bucket size duration, as described elsewhere herein. Accordingly, both L2-based LCHs 210 and LCHs for SRBs and DRBs may be configured with LCP parameters, enabling the UE 120 to more efficiently balance priorities between SRBs, DRBs, and L2 information.

In some examples, the configuration information 205 may indicate intra-LCH prioritization for a group of MAC-CEs 215 within an L2-based LCH 210. For example, within the group of MAC-CEs 215, different MAC-CEs 215 may be configured with different priority levels. In some examples, the priority of a MAC-CE 215 within the group of MAC-CEs 215 may be defined by a wireless communications standard (e.g., 3GPP, which may define a strict or static priority of different MAC-CEs). In some examples, the configuration information 205 may configure the priority for the group of MAC-CEs 215. For instance, in one example, a group of MAC-CEs 215 mapped to the L2-based LCH 210amay include a first MAC-CE 215, a second MAC-CE 215, and a third MAC-CE 215, where the configuration information 205 indicates that the second MAC-CE 215 has the highest priority, the third MAC-CE 215 has the second highest priority, and the first MAC-CE 215 has the lowest priority.

In some examples, the configuration information 205 may dynamically configure an updated LCP for one or more MAC-CEs. This dynamic configuration allows the network node 110 to adjust the priority of LCHs in real-time, based on current network conditions or specific service requirements. For example, the configuration information 205 may include parameters that define the dynamic priority levels for one or more MAC-CEs 215 that are mapped to one or more L2-based LCHs 210, which override the static priorities (e.g., as specified in a wireless communications standard, such as 3GPP). This ensures that data flows are prioritized appropriately, enhancing the network’s ability to manage resources efficiently and maintain QoS.

As shown in FIG. 2, the network node 110 may transmit, and the UE 120 may receive, an uplink grant 235. The uplink grant 235 may provide the UE 120 with permission to transmit data on one or more indicated uplink channels. The uplink grant 235 may include information that the UE 120 uses to perform an uplink transmission 245. This information may include the uplink resource allocation, which specifies the time and frequency resources that the UE 120 can use for uplink transmission 245. The information may also include the MCS that the UE 120 should use, which determines the data rate and robustness of the uplink transmission 245. Additionally, the uplink grant 235 may indicate the power control parameters, which help the UE 120 to adjust a transmission power to ensure optimal signal quality and minimize interference with other UE 120s or wireless devices. The signaling used to transmit the uplink grant 235 may be DCI, which is carried in a physical downlink control channel (PDCCH). The DCI format used for the uplink grant 235 includes various fields that convey the information for the uplink transmission 245. Upon receiving the DCI on the PDCCH, the UE 120 decodes the information and prepares its uplink transmission 245 according to the parameters specified in the uplink grant 235. This process ensures efficient and orderly use of uplink resources, enabling the network node 110 to manage multiple UE 120s and maintain high-quality communication.

After receiving the uplink grant 235, the UE 120 may perform a data prioritization procedure 240. For example, the data prioritization procedure 240 may order the data from the LCHs configured at the UE 120 (e.g., including LCHs for DRBs/SRBs and the L2-based LCHs 210), such that the UE 120 may identify what information to include in the uplink transmission 245 from each of the LCHs. The prioritization steps for LCHs may ensure efficient distribution of available uplink resources based on the priority and data characteristics of each LCH. The process begins by selecting LCHs according to one or more rules (e.g., as specified in technical specification (TS) 36.321 clause 5.4.3.1.2). For example, the one or more rules may include one or more of: buffer status reporting consideration, prioritization by LCH, handling of prioritized bit rate, resource allocation, or equal priority handling. With reference to buffer status reporting consideration, the data prioritization procedure 240 evaluates the buffer status of each LCH. LCHs with a non-zero buffer status (Bj > 0), have data waiting to be transmitted, which may be prioritized for resource allocation. In some examples, the term “buffer status” or “Bj” may also be referred to herein as a “prioritized bit rate bucket size.” The buffer status (Bj) of each LCH may be decremented by the total size of the MAC SDUs (from the uplink transmission 245) that were provided to that LCH. With reference to prioritization by LCH and according to the data prioritization procedure 240, the UE 120 may group the LCHs into logical channel groups (LCGs). Within each LCG, the LCHs may be prioritized based on configured priority levels. Higher priority channels within an LCG are considered before lower priority ones. With reference to handling of prioritized bit rate, the data prioritization procedure 240 takes into account the prioritized bit rate of each LCH. If an LCH has a prioritized bit rate set to infinity, then available data for that LCH should be transmitted before considering the prioritized bit rate of lower-priority channels. With reference to resource allocation, the data prioritization procedure 240 allocates grant resources for the LCHs in a decreasing priority order. The allocation continues until either the data for an LCH is fully transmitted or the grant resources of the uplink grant 235 are exhausted. With reference to equal priority handling, the data prioritization procedure 240 ensures that if multiple LCHs have the same priority level, then the multiple LCHs should be served equally. This means that resources are distributed fairly among channels with equal priority, ensuring balanced treatment and preventing any single channel from monopolizing the resources.

If there are still resources left after the initial allocation, the remaining resources are distributed among all the selected LCHs, again in decreasing priority order, regardless of the current buffer status values. Distribution of the remaining resources continues until either the data for an LCH is fully allocated or the grant resources of the uplink grant 235 are exhausted (whichever occurs first).

In some examples, the value of Bj for a given LCH can be negative, indicating that the given LCH has been allocated more resources than the current buffer status, potentially caused by the prioritization process. In some examples, however, a negative Bj value may prevent the UE 120 from transmitting MAC-CEs 215 not mapped to an L2-based LCH 210, based on the data prioritization procedure 240 prioritizing the transmission of data from LCHs over the transmission of MAC-CEs 215.

If a Bj value for an L2-based LCH 210 is less than or equal to zero (e.g., Bj ≤ 0), then in some examples, the UE 120 may operate in accordance with one or more multiplexing rules to include the MAC-CEs 215 of the L2-based LCH 210 in the uplink transmission 245. The multiplexing rules for including MAC-CEs 215 in the uplink transmission 245 may ensure efficient and prioritized data transmission in accordance with QoS characteristics. These multiplexing rules may dictate that MAC-CEs 215 are included based on priority, with higher priority MAC-CEs 215 (such as buffer status report and PHR) being included first to ensure that latency sensitive control information is prioritized. Additionally, the UE 120 may consider the availability of uplink resources granted by the network node 110, ensuring that there is sufficient space in the uplink transmission 245 to accommodate both the MAC-CEs 215 and the other scheduled data from the LCHs. If resources are limited, higher priority MAC-CEs 215 take precedence. If resources of the uplink transmission 245 are insufficient for one or more MAC-CEs 215 of an L2-based LCH 210, the UE 120 may transmit an SR to request additional uplink resources. These multiplexing rules ensure that latency-sensitive control information is transmitted efficiently, optimizing resource use and maintaining QoS.

In some other examples, the Bj value for L2-based LCHs 210 may be floored at a zero minimum value. By adding a lower limit of zero for Bj values of L2-based LCHs 210, the UE 120 may ensure that the transmissions of MAC-CEs 215 included at the L2-based LCHs 210 are balanced with the transmission of data from other LCHs.

In some examples, the UE 120 may include one or more padding MAC-CEs 215 to the uplink transmission 245 based on the amount of grant resources remaining after allocating grant resources to the data of the LCHs. For example, a padding MAC-CE 215 is a type of MAC-CE 215 used to fill unused space in a MAC PDU to ensure efficient utilization of available uplink resources, such as providing control information such as buffer status when there is insufficient space for additional user data. In some examples, if there are multiple L2-based LCHs 210 configured at the UE 120, or if there are multiple MAC-CEs 215 mapped to one or more L2-based LCHs 210 configured at the UE 120, then the multiple padding MAC-CEs 215 may be included in the uplink transmission 245.

Accordingly, UE 120 may use the data prioritization procedure 240 to allocate data from one or more LCHs (e.g., including the L2-based LCHs 210) to the grant resources of the uplink transmission 245. After allocating the grant resources, the UE 120 may transmit, and the network node 110 may receive, the uplink transmission 245.

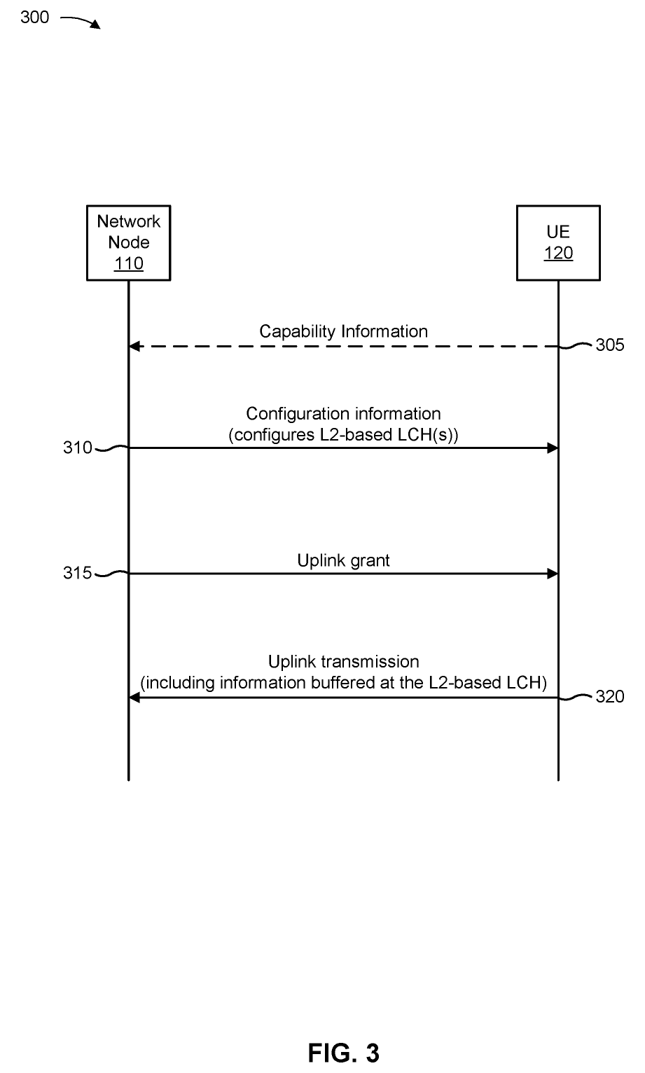

FIG. 3 is a diagram illustrating an example 300 associated with signaling that enables LCH configuration for L2 reporting. Example 300 may implement or be implemented by one or more aspects of FIGS. 1 and 2. For instance, example 300 includes wireless communications between the network node 110 and the UE 120. Alternative examples of the following may be implemented, where some operations are performed in a different order than described, or not described at all. In some cases, one or more operations may include additional features not mentioned below, or further operations may be added. In addition, while example 300 shows operations between the UE 120 and the network node 110, the communications may occur between any number of network devices of various types described herein.

In a first operation 305, the UE 120 may optionally transmit, and the network node 110 may receive, capability information. The capability information may be included in a capability report. The UE 120 may transmit the capability information via an uplink communication, a sidelink communication, a unicast communication, a broadcast communication, a UE 120 assistance information (UAI) communication, a UCI communication, a sidelink control information (SCI) communication, a MAC-CE communication, an RRC communication, a PUCCH, a PUSCH, a sidelink channel (e.g., a physical sidelink control channel (PSCCH), or a physical sidelink shared channel (PSSCH)), among other examples. The capability information may indicate one or more parameters associated with respective capabilities of the UE 120. The one or more parameters may be indicated via respective IEs included in a capability report.

The capability information may indicate whether the UE 120 supports a feature or one or more parameters related to the feature. For example, the capability information may indicate a capability of the UE 120 to support the communication of L2 reports using one or more configured L2-based LCHs (e.g., L2-based LCHs 210). In other words, the capability information may indicate that the UE 120 is capable of operating in accordance with the L2-based LCHs 210. One or more operations described herein may be based on the capability information. For example, the UE 120 may perform one or more operations of example 300 in accordance with the capability information or may receive one or more of configuration information or control information that is in accordance with the capability information. The network node 110 may determine configuration information for the UE 120 based on the capability information.

In a second operation 310, the network node 110 may transmit, and the UE 120 may receive, the configuration information (e.g., the configuration information 205). In some aspects, the UE 120 may receive the configuration information via one or more of system information signaling (e.g., a MIB or a SIB, among other examples), RRC signaling, MAC signaling (e.g., one or more MAC-CEs), or DCI, among other examples.

In some aspects, the configuration information may indicate one or more candidate configurations or communication parameters. In some aspects, the one or more candidate configurations or communication parameters may be selected, activated, or deactivated by a subsequent indication. For example, the subsequent indication may indicate a candidate configuration or communication parameter from the one or more candidate configurations or communication parameters. In some aspects, the subsequent indication may include a dynamic indication, such as one or more MAC-CEs or one or more DCI messages, among other examples.

In some examples, the configuration information may not be expressly signaled to the UE 120. For example, in some aspects, the configuration information may at least partially be defined by a wireless communication standard, such as the 3GPP. In such examples, the network node 110 may not explicitly indicate such configuration information to the UE 120. For example, the UE 120 may optionally obtain at least a portion of the configuration information from a configuration stored by the UE 120 (e.g., an original equipment manufacturer (OEM) configuration). In some aspects, the configuration information may include a parameter or index that is indicative of information defined, or otherwise fixed, by a wireless communication standard, such as the 3GPP (e.g., rather than explicitly indicating the information).

In some examples, the configuration information may indicate multiple LCHs that include an L2-based LCH, where the L2-based LCH may be configured for L2 information. In some examples, multiple LCHs may include multiple L2-based LCHs and other LCHs (such as one or more LCHs for SRBs or one or more LCHs for DRBs).

In some examples, the configuration information indicates a set of parameters for the L2-based LCH. For example, the set of parameters may include one or more of a prioritized bit rate, an LCH priority, or a bucket size duration, as provided elsewhere herein.

In some examples, the configuration information may indicate a set of L2 reports mapped to the L2-based LCH. For example, the set of L2 reports may include one or more of: one or more MAC-CEs (e.g., MAC-CEs 215), one or more RLC control PDUs (e.g., RLC control PDUs 220), one or more PDCP control PDUs (e.g., PDCP control PDUs 225), or one or more SDAP control PDUs (e.g., SDAP control PDUs 230). In some examples, the configuration information may indicate identifiers that point to the MAC-CEs, RLC control PDUs, PDCP control PDUs, or SDAP control PDUs, where the configuration information indicates that the identifiers are mapped to the L2-based LCH. The identifiers may be logical channel identifiers (LCIDs), or some other type of identifier specific to the L2 report indicated.

In some examples, one or more MAC-CEs buffered at the L2-based LCH may be associated with an LCH prioritization scheme (e.g., the data prioritization procedure 240). Conversely, one or more second MAC-CEs not buffered at the L2-based LCH may be associated with a MAC-CE prioritization scheme, as provided elsewhere herein.

In some examples, the L2-based LCH may be a first L2-based LCH of a plurality of L2-based LCHs indicated by the configuration information. For example, the first L2-based LCH may include a group of MAC-CEs (or other control PDUs described herein) based on a QoS associated with the group of MAC-CEs (or the other control PDUs).

In some examples, the configuration information indicates a priority of the L2-based LCH via an LCH priority, as provided elsewhere herein (e.g., the data prioritization procedure 240).

In some examples, the configuration information may indicate a set of priorities respectively associated with a set of MAC-CEs (or other control PDUs described herein) mapped to the L2-based LCH.

In some examples, the configuration information configures a dynamic LCP for a group of MAC-CEs (or the other control PDUs) mapped to the L2-based LCH, where the dynamic LCP may override a static LCP preconfigured for the group of MAC-CEs (or the other control PDUs).

In some examples, the configuration information may indicate that a prioritized bit rate bucket size or buffer status (e.g., Bj) for the L2-based LCH may be configured with a lower limit of zero.

In a third operation 315, the network node 110 may transmit, and the UE 120 may receive, an uplink grant that indicates an amount of resources and a prioritization configured for an uplink transmission. For example, the uplink grant may be an example of the uplink grant 235.

In a fourth operation 320, the UE 120 may transmit, and the network node 110 may receive, an uplink transmission (e.g., the uplink transmission 245). For example, the uplink transmission may include information buffered at the L2-based LCH (e.g., one or more MAC-CEs, RLC control PDUs, PDCP control PDUs, or SDAP control PDUs, or a combination thereof). In some examples, the UE 120 may determine what information (buffered at the L2-based LCH) to include in the uplink transmission based on performing the data prioritization procedure 240. In some examples, the information included in the uplink transmission may include one or more padding MAC-CEs in accordance with a configured prioritization scheme for L2-based LCH. In some examples, the uplink transmission may include multiplexed MAC-CEs mapped to the L2-based LCH based on a prioritized bit rate bucket size or buffer status (e.g., Bj) for the L2-based LCH being less than or equal to zero.

FIG. 4 is a diagram illustrating an example process 400 performed, for example, at a UE or an apparatus of a UE. Example process 400 is an example where the apparatus or the UE (e.g., UE 120) performs operations associated with LCH configuration for L2 reporting.

As shown in FIG. 4, in some aspects, process 400 may include receiving, from a network node, configuration information indicating a plurality of LCHs that include an L2-based LCH, where the L2-based LCH is configured for L2 information (block 410). For example, the UE (e.g., using reception component 602 or communication manager 606, depicted in FIG. 6) may receive, from a network node, configuration information indicating a plurality of LCHs that include an L2-based LCH, where the L2-based LCH is configured for L2 information, as described above.

As further shown in FIG. 4, in some aspects, process 400 may include receiving, from the network node, an uplink grant that indicates an amount of resources and a prioritization configured for an uplink transmission (block 420). For example, the UE (e.g., using reception component 602 or communication manager 606, depicted in FIG. 6) may receive, from the network node, an uplink grant that indicates an amount of resources and a prioritization configured for an uplink transmission, as described above.

As further shown in FIG. 4, in some aspects, process 400 may include transmitting, to the network node, the uplink transmission, where the uplink transmission includes information buffered at the L2-based LCH (block 430). For example, the UE (e.g., using transmission component 604 or communication manager 606, depicted in FIG. 6) may transmit, to the network node, the uplink transmission, where the uplink transmission includes information buffered at the L2-based LCH, as described above.

Process 400 may include additional aspects, such as any single aspect or any combination of aspects described below or in connection with one or more other processes provided elsewhere herein.

In a first aspect, the configuration information indicates a set of parameters for the L2-based LCH, the set of parameters comprising one or more of a prioritized bit rate, an LCH priority, or a bucket size duration.

In a second aspect, alone or in combination with the first aspect, the configuration information indicates a set of L2 reports mapped to the L2-based LCH, where the set of L2 reports comprises one or more of one or more MAC-CEs, one or more RLC PDUs, one or more PDCP PDUs, or one or more SDAP PDUs.

In a third aspect, alone or in combination with one or more of the first and second aspects, one or more first MAC-CEs buffered at the L2-based LCH are associated with an LCH prioritization scheme, and one or more second MAC-CEs not buffered at the L2-based LCH are associated with a MAC-CE prioritization scheme.

In a fourth aspect, alone or in combination with one or more of the first through third aspects, the L2-based LCH is a first L2-based LCH of a plurality of L2-based LCHs indicated by the configuration information, and the first L2-based LCH includes a group of MAC-CEs based at least in part on a quality of service associated with the group of MAC-CEs.

In a fifth aspect, alone or in combination with one or more of the first through fourth aspects, the configuration information indicates a priority of the L2-based LCH via an LCH priority scheme.

In a sixth aspect, alone or in combination with one or more of the first through fifth aspects, the configuration information indicates a set of priorities respectively associated with a set of MAC-CEs mapped to the L2-based LCH.

In a seventh aspect, alone or in combination with one or more of the first through sixth aspects, the information included in the uplink transmission comprises one or more padding MAC-CEs in accordance with a configured prioritization scheme for L2-based LCH.

In an eighth aspect, alone or in combination with one or more of the first through seventh aspects, the uplink transmission comprises multiplexed MAC-CEs mapped to the L2-based LCH based at least in part on a prioritized bit rate bucket size for the L2-based LCH being less than or equal to zero.

In a ninth aspect, alone or in combination with one or more of the first through eighth aspects, a prioritized bit rate bucket size for the L2-based LCH is configured with a lower limit of zero.

In a tenth aspect, alone or in combination with one or more of the first through ninth aspects, the configuration information configures a dynamic LCP for a group of MAC-CEs mapped to the L2-based LCH, where the dynamic LCP overrides a static LCP preconfigured for the group of MAC-CEs.

Although FIG. 4 shows example blocks of process 400, in some aspects, process 400 may include additional blocks, fewer blocks, different blocks, or differently arranged blocks than those depicted in FIG. 4. Additionally, or alternatively, two or more of the blocks of process 400 may be performed in parallel.

FIG. 5 is a diagram illustrating an example process 500 performed, for example, at a network node or an apparatus of a network node. Example process 500 is an example where the apparatus or the network node (e.g., network node 110) performs operations associated with LCH configuration for L2 reporting.

As shown in FIG. 5, in some aspects, process 500 may include transmitting, to a UE, configuration information indicating a plurality of LCHs that include an L2-based LCH, where the L2-based LCH is configured for L2 information (block 510). For example, the network node (e.g., using transmission component 704 or communication manager 706, depicted in FIG. 7) may transmit, to a UE, configuration information indicating a plurality of LCHs that include an L2-based LCH, where the L2-based LCH is configured for L2 information, as described above.

As further shown in FIG. 5, in some aspects, process 500 may include transmitting, to the UE, an uplink grant that indicates an amount of resources and a prioritization configured for an uplink transmission (block 520). For example, the network node (e.g., using transmission component 704 or communication manager 706, depicted in FIG. 7) may transmit, to the UE, an uplink grant that indicates an amount of resources and a prioritization configured for an uplink transmission, as described above.

As further shown in FIG. 5, in some aspects, process 500 may include receiving, from the UE, the uplink transmission, where the uplink transmission includes information buffered at the L2-based LCH (block 530). For example, the network node (e.g., using reception component 702 or communication manager 706, depicted in FIG. 7) may receive, from the UE, the uplink transmission, where the uplink transmission includes information buffered at the L2-based LCH, as described above.

Process 500 may include additional aspects, such as any single aspect or any combination of aspects described below or in connection with one or more other processes provided elsewhere herein.

In a first aspect, the configuration information indicates a set of parameters for the L2-based LCH, the set of parameters comprising one or more of a prioritized bit rate, an LCH priority, or a bucket size duration.

In a second aspect, alone or in combination with the first aspect, the configuration information indicates a set of L2 reports mapped to the L2-based LCH, where the set of L2 reports comprises one or more of one or more MAC-CEs, one or more RLC PDUs, one or more PDCP PDUs, or one or more SDAP PDUs.

In a third aspect, alone or in combination with one or more of the first and second aspects, one or more first MAC-CEs buffered at the L2-based LCH are associated with an LCH prioritization scheme, and one or more second MAC-CEs not buffered at the L2-based LCH are associated with a MAC-CE prioritization scheme.

In a fourth aspect, alone or in combination with one or more of the first through third aspects, the L2-based LCH is a first L2-based LCH of a plurality of L2-based LCHs indicated by the configuration information, and the first L2-based LCH includes a group of MAC-CEs based at least in part on a quality of service associated with the group of MAC-CEs.

In a fifth aspect, alone or in combination with one or more of the first through fourth aspects, the configuration information indicates a priority of the L2-based LCH via a logical channel priority scheme.

In a sixth aspect, alone or in combination with one or more of the first through fifth aspects, the configuration information indicates a set of priorities respectively associated with a set of MAC-CEs mapped to the L2-based LCH.

In a seventh aspect, alone or in combination with one or more of the first through sixth aspects, the information included in the uplink transmission comprises one or more padding MAC-CEs in accordance with a configured prioritization scheme for L2-based LCH.

In an eighth aspect, alone or in combination with one or more of the first through seventh aspects, the uplink transmission comprises multiplexed MAC-CEs mapped to the L2-based LCH based at least in part on a prioritized bit rate bucket size for the L2-based LCH being less than or equal to zero.

In a ninth aspect, alone or in combination with one or more of the first through eighth aspects, a prioritized bit rate bucket size for the L2-based LCH is configured with a lower limit of zero.

In a tenth aspect, alone or in combination with one or more of the first through ninth aspects, the configuration information configures a dynamic LCP for a group of MAC-CEs mapped to the L2-based LCH, where the dynamic LCP overrides a static LCP preconfigured for the group of MAC-CEs.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram of an example apparatus 600 for wireless communication. The apparatus 600 may be a UE, or a UE may include the apparatus 600. In some aspects, the apparatus 600 includes a reception component 602, a transmission component 604, or a communication manager 606, which may be in communication with one another (for example, via one or more buses or one or more other components). In some aspects, the communication manager 606 is the communication manager 150 described in connection with FIG. 1. As shown, the apparatus 600 may communicate with another apparatus 608, such as a UE or a network node (such as a CU, a DU, an RU, or a base station), using the reception component 602 and the transmission component 604. The communication manager 606 may be included in, or implemented via, a processing system (for example, the processing system 140 described in connection with FIG. 1) of the UE.

In some aspects, the apparatus 600 may be configured to perform one or more operations described herein in connection with FIGS. 2 and 3. Additionally, or alternatively, the apparatus 600 may be configured to perform one or more processes described herein, such as process 400 of FIG. 4. In some aspects, the apparatus 600 or one or more components shown in FIG. 6 may include one or more components of the UE described in connection with FIG. 1. Additionally, or alternatively, one or more components shown in FIG. 6 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 602 may receive communications, such as reference signals, control information, data communications, or a combination thereof, from the apparatus 608. The reception component 602 may provide received communications to one or more other components of the apparatus 600. In some aspects, the reception component 602 may perform signal processing on the received communications, and may provide the processed signals to the one or more other components of the apparatus 600. In some aspects, the reception component 602 may include one or more components of the UE described above in connection with FIG. 1, such as a radio, one or more RF chains, one or more transceivers, or one or more modems, each of which may in turn be coupled with one or more antennas of the UE.

The transmission component 604 may transmit communications, such as reference signals, control information, data communications, or a combination thereof, to the apparatus 608. In some aspects, one or more other components of the apparatus 600 may generate communications and may provide the generated communications to the transmission component 604 for transmission to the apparatus 608. In some aspects, the transmission component 604 may perform signal processing on the generated communications, and may transmit the processed signals to the apparatus 608. In some aspects, the transmission component 604 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 604 may be co-located with the reception component 602.

The communication manager 606 may support operations of the reception component 602 or the transmission component 604. For example, the communication manager 606 may receive information associated with configuring reception of communications by the reception component 602 or transmission of communications by the transmission component 604. Additionally, or alternatively, the communication manager 606 may generate or provide control information to the reception component 602 or the transmission component 604 to control reception or transmission of communications.

The reception component 602 may receive, from a network node, configuration information indicating a plurality of LCHs that include an L2-based LCH, wherein the L2-based LCH is configured for L2 information. The reception component 602 may receive, from the network node, an uplink grant that indicates an amount of resources and a prioritization configured for an uplink transmission. The transmission component 604 may transmit, to the network node, the uplink transmission, wherein the uplink transmission includes information buffered at the L2-based LCH.

The number and arrangement of components shown in FIG. 6 are provided as an example. In practice, there may be additional components, fewer components, different components, or differently arranged components than those shown in FIG. 6. Furthermore, two or more components shown in FIG. 6 may be implemented within a single component, or a single component shown in FIG. 6 may be implemented as multiple, distributed components. Additionally, or alternatively, a set of (one or more) components shown in FIG. 6 may perform one or more functions described as being performed by another set of components shown in FIG. 6.

FIG. 7 is a diagram of an example apparatus 700 for wireless communication. The apparatus 700 may be a network node, or a network node may include the apparatus 700. In some aspects, the apparatus 700 includes a reception component 702, a transmission component 704, or a communication manager 706, which may be in communication with one another (for example, via one or more buses or one or more other components). In some aspects, the communication manager 706 is the communication manager 155 described in connection with FIG. 1. As shown, the apparatus 700 may communicate with another apparatus 708, such as a UE or a network node (such as a CU, a DU, an RU, or a base station), using the reception component 702 and the transmission component 704. The communication manager 706 may be included in, or implemented via, a processing system (for example, the processing system 145 described in connection with FIG. 1) of the network node.

In some aspects, the apparatus 700 may be configured to perform one or more operations described herein in connection with FIGS. 2 and 3. Additionally, or alternatively, the apparatus 700 may be configured to perform one or more processes described herein, such as process 500 of FIG. 5. In some aspects, the apparatus 700 or one or more components shown in FIG. 7 may include one or more components of the network node described in connection with FIG. 1. Additionally, or alternatively, one or more components shown in FIG. 7 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 702 may receive communications, such as reference signals, control information, data communications, or a combination thereof, from the apparatus 708. The reception component 702 may provide received communications to one or more other components of the apparatus 700. In some aspects, the reception component 702 may perform signal processing on the received communications, and may provide the processed signals to the one or more other components of the apparatus 700. In some aspects, the reception component 702 may include one or more components of the network node described above in connection with FIG. 1, such as a radio, one or more RF chains, one or more transceivers, or one or more modems, each of which may in turn be coupled with one or more antennas of the network node. In some aspects, the reception component 702 or the transmission component 704 may include or may be included in a network interface. The network interface may be configured to obtain or output signals for the apparatus 700 via one or more communications links, such as a backhaul link, a midhaul link, or a fronthaul link.

The transmission component 704 may transmit communications, such as reference signals, control information, data communications, or a combination thereof, to the apparatus 708. In some aspects, one or more other components of the apparatus 700 may generate communications and may provide the generated communications to the transmission component 704 for transmission to the apparatus 708. In some aspects, the transmission component 704 may perform signal processing on the generated communications, and may transmit the processed signals to the apparatus 708. In some aspects, the transmission component 704 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 704 may be co-located with the reception component 702.

The communication manager 706 may support operations of the reception component 702 or the transmission component 704. For example, the communication manager 706 may receive information associated with configuring reception of communications by the reception component 702 or transmission of communications by the transmission component 704. Additionally, or alternatively, the communication manager 706 may generate or provide control information to the reception component 702 or the transmission component 704 to control reception or transmission of communications.

The transmission component 704 may transmit, to a UE, configuration information indicating a plurality of LCHs that include an L2-based LCH, wherein the L2-based LCH is configured for L2 information. The transmission component 704 may transmit, to the UE, an uplink grant that indicates an amount of resources and a prioritization configured for an uplink transmission. The reception component 702 may receive, from the UE, the uplink transmission, wherein the uplink transmission includes information buffered at the L2-based LCH.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

The following provides an overview of some Aspects of the present disclosure:

Aspect 1: A method of wireless communication performed by a user equipment (UE), comprising: receiving, from a network node, configuration information indicating a plurality of logical channels (LCHs) that include a Layer 2 (L2)-based LCH, wherein the L2-based LCH is configured for L2 information; receiving, from the network node, an uplink grant that indicates an amount of resources and a prioritization configured for an uplink transmission; and transmitting, to the network node, the uplink transmission, wherein the uplink transmission includes information buffered at the L2-based LCH.

Aspect 2: The method of Aspect 1, wherein the configuration information indicates a set of parameters for the L2-based LCH, the set of parameters comprising one or more of a prioritized bit rate, an LCH priority, or a bucket size duration.

Aspect 3: The method of any of Aspects 1-2, wherein the configuration information indicates a set of L2 reports mapped to the L2-based LCH, wherein the set of L2 reports comprises one or more of: one or more medium access control (MAC) control elements (MAC-CEs), one or more radio link control protocol data units (PDUs), one or more packet data convergence protocol PDUs, or one or more service data adaptation protocol PDUs.

Aspect 4: The method of any of Aspects 1-3, wherein one or more first medium access control (MAC) control elements (MAC-CEs) buffered at the L2-based LCH are associated with an LCH prioritization scheme, and wherein one or more second MAC-CEs not buffered at the L2-based LCH are associated with a MAC-CE prioritization scheme.

Aspect 5: The method of any of Aspects 1-4, wherein the L2-based LCH is a first L2-based LCH of a plurality of L2-based LCHs indicated by the configuration information, and wherein the first L2-based LCH includes a group of medium access control (MAC) control elements (MAC-CEs) based at least in part on a quality of service associated with the group of MAC-CEs.

Aspect 6: The method of any of Aspects 1-5, wherein the configuration information indicates a priority of the L2-based LCH via a logical channel priority scheme.

Aspect 7: The method of any of Aspects 1-6, wherein the configuration information indicates a set of priorities respectively associated with a set of medium access control (MAC) control elements (MAC-CEs) mapped to the L2-based LCH.

Aspect 8: The method of any of Aspects 1-7, wherein the information included in the uplink transmission comprises one or more padding medium access control (MAC) control elements (MAC-CEs) in accordance with a configured prioritization scheme for L2-based LCH.

Aspect 9: The method of any of Aspects 1-8, wherein the uplink transmission comprises multiplexed medium access control (MAC) control elements (MAC-CEs) mapped to the L2-based LCH based at least in part on a prioritized bit rate bucket size for the L2-based LCH being less than or equal to zero.

Aspect 10: The method of any of Aspects 1-9, wherein a prioritized bit rate bucket size for the L2-based LCH is configured with a lower limit of zero.

Aspect 11: The method of any of Aspects 1-10, wherein the configuration information configures a dynamic logical channel priority (LCP) for a group of medium access control (MAC) control elements (MAC-CEs) mapped to the L2-based LCH, where the dynamic LCP overrides a static LCP preconfigured for the group of MAC-CEs.

Aspect 12: A method of wireless communication performed by a network node, comprising: transmitting, to a user equipment (UE), configuration information indicating a plurality of logical channels (LCHs) that include a Layer 2 (L2)-based LCH, wherein the L2-based LCH is configured for L2 information; transmitting, to the UE, an uplink grant that indicates an amount of resources and a prioritization configured for an uplink transmission; and receiving, from the UE, the uplink transmission, wherein the uplink transmission includes information buffered at the L2-based LCH.

Aspect 13: The method of Aspect 12, wherein the configuration information indicates a set of parameters for the L2-based LCH, the set of parameters comprising one or more of a prioritized bit rate, an LCH priority, or a bucket size duration.

Aspect 14: The method of any of Aspects 12-13, wherein the configuration information indicates a set of L2 reports mapped to the L2-based LCH, wherein the set of L2 reports comprises one or more of: one or more medium access control (MAC) control elements (MAC-CEs), one or more radio link control protocol data units (PDUs), one or more packet data convergence protocol PDUs, or one or more service data adaptation protocol PDUs.

Aspect 15: The method of any of Aspects 12-14, wherein one or more first medium access control (MAC) control elements (MAC-CEs) buffered at the L2-based LCH are associated with an LCH prioritization scheme, and wherein one or more second MAC-CEs not buffered at the L2-based LCH are associated with a MAC-CE prioritization scheme.

Aspect 16: The method of any of Aspects 12-15, wherein the L2-based LCH is a first L2-based LCH of a plurality of L2-based LCHs indicated by the configuration information, and wherein the first L2-based LCH includes a group of medium access control (MAC) control elements (MAC-CEs) based at least in part on a quality of service associated with the group of MAC-CEs.

Aspect 17: The method of any of Aspects 12-16, wherein the configuration information indicates a priority of the L2-based LCH via a logical channel priority scheme.

Aspect 18: The method of any of Aspects 12-17, wherein the configuration information indicates a set of priorities respectively associated with a set of medium access control (MAC) control elements (MAC-CEs) mapped to the L2-based LCH.

Aspect 19: The method of any of Aspects 12-18, wherein the information included in the uplink transmission comprises one or more padding medium access control (MAC) control elements (MAC-CEs) in accordance with a configured prioritization scheme for L2-based LCH.

Aspect 20: The method of any of Aspects 12-19, wherein the uplink transmission comprises multiplexed medium access control (MAC) control elements (MAC-CEs) mapped to the L2-based LCH based at least in part on a prioritized bit rate bucket size for the L2-based LCH being less than or equal to zero.

Aspect 21: The method of any of Aspects 12-20, wherein a prioritized bit rate bucket size for the L2-based LCH is configured with a lower limit of zero.

Aspect 22: The method of any of Aspects 12-21, wherein the configuration information configures a dynamic logical channel priority (LCP) for a group of medium access control (MAC) control elements (MAC-CEs) mapped to the L2-based LCH, where the dynamic LCP overrides a static LCP preconfigured for the group of MAC-CEs.

Aspect 23: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-22.

Aspect 24: An apparatus for wireless communication at a device, the apparatus comprising one or more memories and one or more processors coupled to the one or more memories, the one or more processors configured to cause the device to perform the method of one or more of Aspects 1-22.

Aspect 25: An apparatus for wireless communication, the apparatus comprising at least one means for performing the method of one or more of Aspects 1-22.

Aspect 26: A non-transitory computer-readable medium storing code for wireless communication, the code comprising instructions executable by one or more processors to perform the method of one or more of Aspects 1-22.

Aspect 27: A non-transitory computer-readable medium storing a set of instructions for wireless communication, the set of instructions comprising one or more instructions that, when executed by one or more processors of a device, cause the device to perform the method of one or more of Aspects 1-22.

Aspect 28: A device for wireless communication, the device comprising a processing system that includes one or more processors and one or more memories coupled with the one or more processors, the processing system configured to cause the device to perform the method of one or more of Aspects 1-22.

Aspect 29: An apparatus for wireless communication at a device, the apparatus comprising one or more memories and one or more processors coupled to the one or more memories, the one or more processors individually or collectively configured to cause the device to perform the method of one or more of Aspects 1-22.

Aspect 30: A device comprising a processing system that includes one or more processors and one or more code-storing memories coupled with the one or more processors, the processing system configured to cause the device to perform the method of one or more of Aspects 1-22.

Aspect 31: A device comprising a processing system that includes processor circuitry and code-storing memory circuitry, the processing system configured to cause the device to perform the method of one or more of Aspects 1-22.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE), comprising:
a processing system that includes processor circuitry and code-storing memory circuitry, the processing system configured to cause the UE to:
receive, from a network node, configuration information indicating a plurality of logical channels (LCHs) that include a Layer 2 (L2)-based LCH, wherein the L2-based LCH is configured for L2 information;
receive, from the network node, an uplink grant that indicates an amount of resources and a prioritization configured for an uplink transmission; and
transmit, to the network node, the uplink transmission, wherein the uplink transmission includes information buffered at the L2-based LCH.

2. The UE of claim 1, wherein the configuration information indicates a set of parameters for the L2-based LCH, the set of parameters comprising one or more of a prioritized bit rate, an LCH priority, or a bucket size duration.

3. The UE of claim 1, wherein the configuration information indicates a set of L2 reports mapped to the L2-based LCH, wherein the set of L2 reports comprises one or more of:
one or more medium access control (MAC) control elements (MAC-CEs),
one or more radio link control protocol data units (PDUs),
one or more packet data convergence protocol PDUs, or
one or more service data adaptation protocol PDUs.

4. The UE of claim 1, wherein one or more first medium access control (MAC) control elements (MAC-CEs) buffered at the L2-based LCH are associated with an LCH prioritization scheme, and wherein one or more second MAC-CEs not buffered at the L2-based LCH are associated with a MAC-CE prioritization scheme.

5. The UE of claim 1, wherein the L2-based LCH is a first L2-based LCH of a plurality of L2-based LCHs indicated by the configuration information, and wherein the first L2-based LCH includes a group of medium access control (MAC) control elements (MAC-CEs) based at least in part on a quality of service associated with the group of MAC-CEs.

6. The UE of claim 1, wherein the configuration information indicates a priority of the L2-based LCH via a logical channel priority scheme.

7. The UE of claim 1, wherein the configuration information indicates a set of priorities respectively associated with a set of medium access control (MAC) control elements (MAC-CEs) mapped to the L2-based LCH.

8. The UE of claim 1, wherein the information included in the uplink transmission comprises one or more padding medium access control (MAC) control elements (MAC-CEs) in accordance with a configured prioritization scheme for L2-based LCH.

9. The UE of claim 1, wherein the uplink transmission comprises multiplexed medium access control (MAC) control elements (MAC-CEs) mapped to the L2-based LCH based at least in part on a prioritized bit rate bucket size for the L2-based LCH being less than or equal to zero.

10. The UE of claim 1, wherein a prioritized bit rate bucket size for the L2-based LCH is configured with a lower limit of zero.

11. The UE of claim 1, wherein the configuration information configures a dynamic logical channel priority (LCP) for a group of medium access control (MAC) control elements (MAC-CEs) mapped to the L2-based LCH, where the dynamic LCP overrides a static LCP preconfigured for the group of MAC-CEs.

12. A method of wireless communication performed by a user equipment (UE), comprising:
receiving, from a network node, configuration information indicating a plurality of logical channels (LCHs) that include a Layer 2 (L2)-based LCH, wherein the L2-based LCH is configured for L2 information;
receiving, from the network node, an uplink grant that indicates an amount of resources and a prioritization configured for an uplink transmission; and
transmitting, to the network node, the uplink transmission, wherein the uplink transmission includes information buffered at the L2-based LCH.

13. The method of claim 12, wherein the configuration information indicates a set of parameters for the L2-based LCH, the set of parameters comprising one or more of a prioritized bit rate, an LCH priority, or a bucket size duration.

14. The method of claim 12, wherein the configuration information indicates a set of L2 reports mapped to the L2-based LCH, wherein the set of L2 reports comprises one or more of:
one or more medium access control (MAC) control elements (MAC-CEs),
one or more radio link control protocol data units (PDUs),
one or more packet data convergence protocol PDUs, or
one or more service data adaptation protocol PDUs.

15. The method of claim 12, wherein one or more first medium access control (MAC) control elements (MAC-CEs) buffered at the L2-based LCH are associated with an LCH prioritization scheme, and wherein one or more second MAC-CEs not buffered at the L2-based LCH are associated with a MAC-CE prioritization scheme.

16. The method of claim 12, wherein the L2-based LCH is a first L2-based LCH of a plurality of L2-based LCHs indicated by the configuration information, and wherein the first L2-based LCH includes a group of medium access control (MAC) control elements (MAC-CEs) based at least in part on a quality of service associated with the group of MAC-CEs.

17. The method of claim 12, wherein the configuration information indicates a priority of the L2-based LCH via a logical channel priority scheme.

18. The method of claim 12, wherein the configuration information indicates a set of priorities respectively associated with a set of medium access control (MAC) control elements (MAC-CEs) mapped to the L2-based LCH.

19. The method of claim 12, wherein the information included in the uplink transmission comprises one or more padding medium access control (MAC) control elements (MAC-CEs) in accordance with a configured prioritization scheme for L2-based LCH.

20. An apparatus for wireless communication, comprising:
means for receiving, from a network node, configuration information indicating a plurality of logical channels (LCHs) that include a Layer 2 (L2)-based LCH, wherein the L2-based LCH is configured for L2 information;
means for receiving, from the network node, an uplink grant that indicates an amount of resources and a prioritization configured for an uplink transmission; and
means for transmitting, to the network node, the uplink transmission, wherein the uplink transmission includes information buffered at the L2-based LCH.
